(19) United States
(12) Patent Application Publication
(10) Pub. No.: US 2016/0368544 A1
(43) Pub. Date: Dec. 22, 2016

(54) 3-PIECE DAY CAB ROOF FAIRING

(71) Applicants: Louis D. Heilaneh, Lewisville, TX (US); Bradley D. Powell, Corinth, TX (US); Hanson Morris, Fort Worth, TX (US)

(72) Inventors: Louis D. Heilaneh, Lewisville, TX (US); Bradley D. Powell, Corinth, TX (US); Hanson Morris, Fort Worth, TX (US)

(73) Assignee: PACCAR INC, Bellevue, WA (US)

(21) Appl. No.: 14/746,395

(22) Filed: Jun. 22, 2015

(51) Int. Cl. B62D 35/00

(52) U.S. Cl. CPC B62D 35/001

(57) ABSTRACT

A three-piece roof fairing is mounted on a cab of a vehicle. The vehicle includes a trailer located behind the cab. The trailer includes a top leading edge, a front surface below the top leading edge, and a top surface behind the top leading edge. The roof fairing includes a front portion and a top portion. A characteristic of one or more of the front portion or the top portion is selected such that the air flow passing across a front of the cab passes over the front portion and the top portion of the roof fairing and is directed onto the top surface of the trailer beyond the top leading edge.

### CROSS-REFERENCES TO RELATED APPLICATIONS

This application is related to U.S. application Ser. No. 29/530,906, entitled “CAB ROOF FAIRING,” U.S. application Ser. No. 29/530,908, entitled “CENTER PANEL OF ROOF FAIRING,” and U.S. application Ser. No. 29/530,910, entitled “SIDE PANEL OF ROOF FAIRING,” all filed on even date herewith, the contents of which are hereby incorporated by reference in their entirety.

### BACKGROUND

Numerous means have been sought to improve the fuel-efficiency of moving bodies and, especially, moving bluff bodies by reducing their aerodynamic drag. In the field of surface transportation, and particularly in the long-haul trucking industry, even small improvements in fuel efficiency can reduce annual operating costs significantly. It is therefore advantageous in the design of a vehicle to reduce drag forces, thereby increasing the aerodynamic properties and efficiency of the vehicle.

The over-the-highway cargo-hauling tractor-trailer combination is one vehicle that experiences excessive aerodynamic drag. Generally described, tractor-trailer combinations typically include a tractor having a so-called fifth wheel by which a box-like semi-trailer may be attached to the tractor by an articulated connection for transportation of the cargo trailer. The shape of the conventional cargo trailer is essentially a rectangular box having a flat, rectangular roof and matching floor, along with flat, rectangular side panels. The fore and aft vertical surfaces of such trailers are also generally flat rectangular surfaces. The aft section of the trailer is supportably mounted on one or more wheel assemblies. Most large long-haul cargo trailers similar to those described above exhibit less than optimal aerodynamic performance during highway operation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a vehicle includes a cab including a front, a trailer located behind the cab, and a roof fairing located on a roof of the cab. The trailer includes a top leading edge, a front surface below the top leading edge, and a top surface behind the top leading edge. The roof fairing includes a front portion and a top portion and a characteristic of one or more of the front portion or the top portion is selected such that the air flow passing across the front of the cab passes over the front portion and the top portion and is directed onto the top surface of the trailer beyond the top leading edge.

In one example the characteristic of one or more of the front portion or the top portion includes one or more of an angle of the front portion, an angle of the top portion, an angle between the front portion and the top portion, or a radius between the front portion and the top portion. In another example, the characteristic of one or more of the front portion or the top portion is further selected based on a height difference between a trailing edge of the top portion and the top leading edge. In another example, the characteristic of one or more of the front portion or the top portion is selected based on a gap between a trailing edge of the top portion and the top leading edge.

In another example, the front portion has an angle that is based on the front of the cab. In another example, the front of the cab includes a windshield. In another example, the roof fairing includes a central panel, a first side panel, and a second side panel, and wherein the central panel includes the front portion and the top portion. In another example, the first side panel includes an extension portion. In another example, the vehicle further includes a side fairing, and wherein the side fairing has a profile similar to a profile of the extended portion. In another example, the side fairing is configured to direct an airflow along a side of the cab onto a side surface of the trailer such that the airflow along the side of the cab does not impinge on the front surface of the trailer.

In another embodiment, a cab roof fairing assembly includes a central panel, a first side panel, and a second side panel. The central panel is contoured to form a front portion and a top portion, and the central panel includes a first side edge and a second side edge. The first side panel includes a third side edge and the first side panel is coupled to the central panel such that the first side edge of the central panel is aligned with the third side edge of the first side panel. The second side panel includes a fourth side edge and the second side panel is coupled to the central panel such that the second side edge of the central panel is aligned with the fourth side edge of the second side panel. When the cab roof fairing assembly is mounted on a cab of a vehicle and the vehicle includes a trailer that has a top leading edge and a top surface behind the top leading edge, the front portion and the top portion are arranged to direct air passing up from the cab toward the top surface of the trailer beyond the top leading edge.

In one example, the cab roof fairing assembly further includes an inner ridge extending from the front portion to the top portion of the central panel. In another example, the cab roof fairing assembly further includes a first outer ridge extending from the front portion to the top portion of the central panel and a second outer ridge extending from the front portion to the top portion of the central panel, where the first outer ridge is located between the inner ridge and the first side edge and the second outer ridge is located between the inner ridge and the second side edge. In another example, the central panel includes a first shoulder portion located between the first outer ridge and the first side edge, and wherein the central panel includes a second shoulder portion located between the second outer ridge and the second side edge.

In another example, the first side panel includes a depressed portion. In another example, the first depressed portion extends to and is flush with a back edge of the first side panel. In another example, an angle between the front portion of the central panel and the top portion of the central panel is in a range from about 115° to about 120°. In another example, a radius between the front portion of the central panel and the top portion of the central panel is in a range from about 15 inches to about 19 inches. In another example, the first side panel includes an extended portion and the extended portion extends further away from the top portion of the central panel than the front portion extends away from the top portion.

### DESCRIPTION OF THE DRAWINGS

The foregoing aspects and many of the attendant advantages of disclosed subject matter will become more readily appreciated as the same become better understood by reference to the following detailed description, when taken in conjunction with the accompanying drawings, wherein:

FIGS. 1A to 1H depict, respectively, a perspective view, another perspective view, a front view, a right side view, a left side view, a horizontal cross-sectional view, a vertical cross-sectional view, and an exploded view of an embodiment of a three-piece cab roof fairing;

FIGS. 2A to 2C depict, respectively, perspective, side, and top views of an embodiment of a vehicle with a roof fairing, in accordance with any of the roof fairings described herein;

FIGS. 3A to 3D depict airflows over a vehicle and embodiments of roof fairings, in accordance with any of the embodiments described herein; and

FIGS. 4A to 4B depict airflows over a vehicle and embodiments of roof fairings, in accordance with any of the embodiments described herein.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The following discussion provides examples of systems and methods for improving the aerodynamic efficiency (e.g., reduce drag) of vehicles, such as class 8 tractor-trailer combinations. To improve the aerodynamic efficiency of the combination, examples described herein provide a three-piece cab roof fairing positioned on the cab in front of the fore section of the trailer. In some examples described herein, the three-piece cab roof fairing is positioned to direct, around the trailer, air that is coming up the cab and air passing immediately above the cab. In use, the three-piece cab roof fairing improves air flow above the cab and in front of the trailer, thereby reducing drag.

Although embodiments of the present disclosure will be described with reference to a semi-truck or tractor, one skilled in the relevant art will appreciate that the disclosed embodiments are illustrative in nature, and therefore, should not be construed as limited to applications with a semi-truck or tractor. It should therefore be apparent that the methods and systems of the present disclosure have wide application, and may be used in any situation where a reduction in the drag forces on a bluff body is desirable.

For the purposes of this detailed description, the terms “about,” “approximately,” etc., shall mean plus or minus 5% of the stated value or condition. It should be noted that for purposes of this disclosure, terminology such as “upper,” “lower,” “vertical,” “horizontal,” “fore,” “aft,” “inner,” “outer,” etc., should be construed as descriptive and not limiting the scope of the present invention, as claimed.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

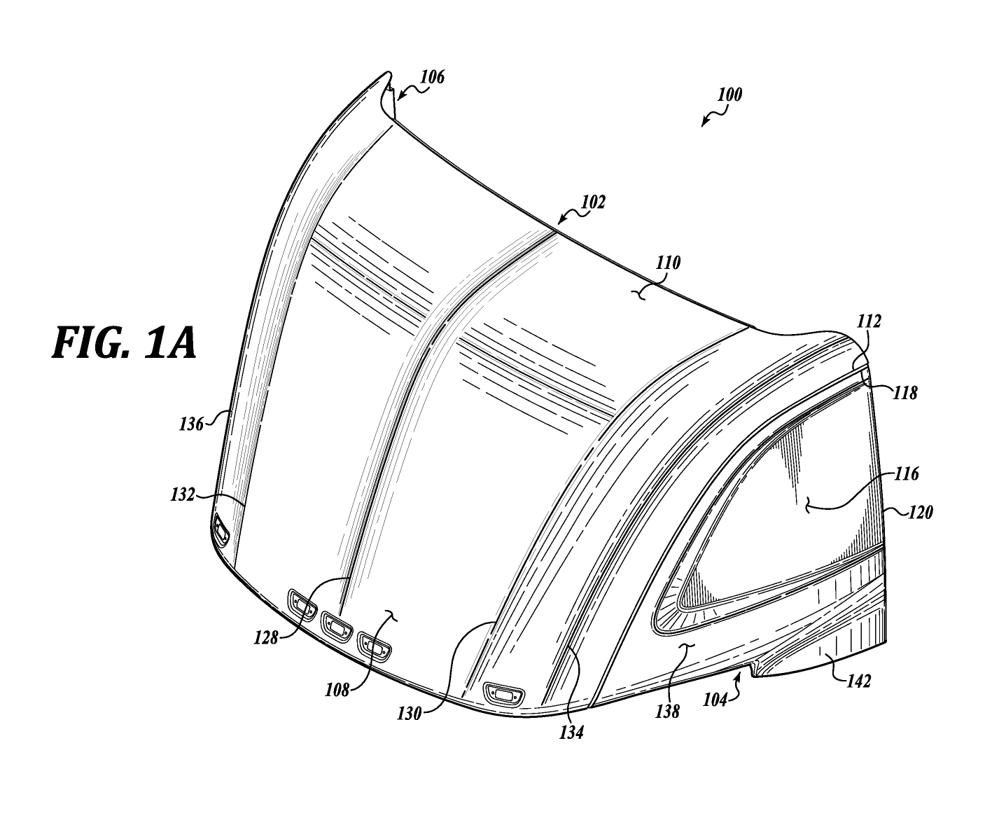

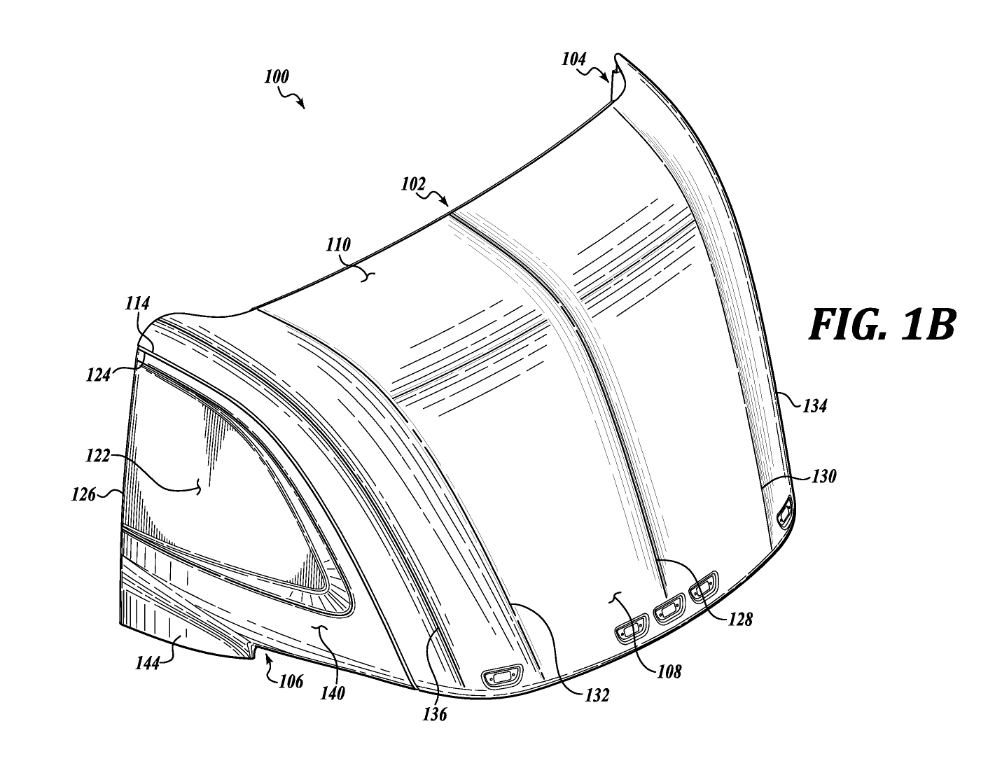

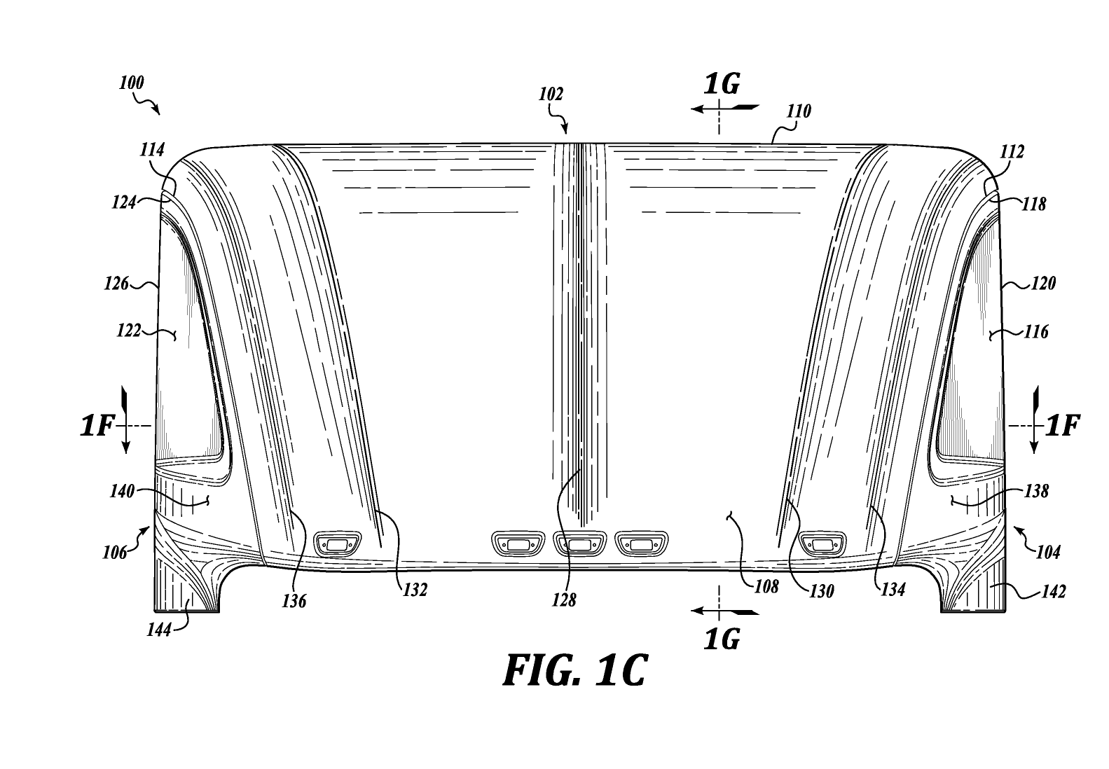

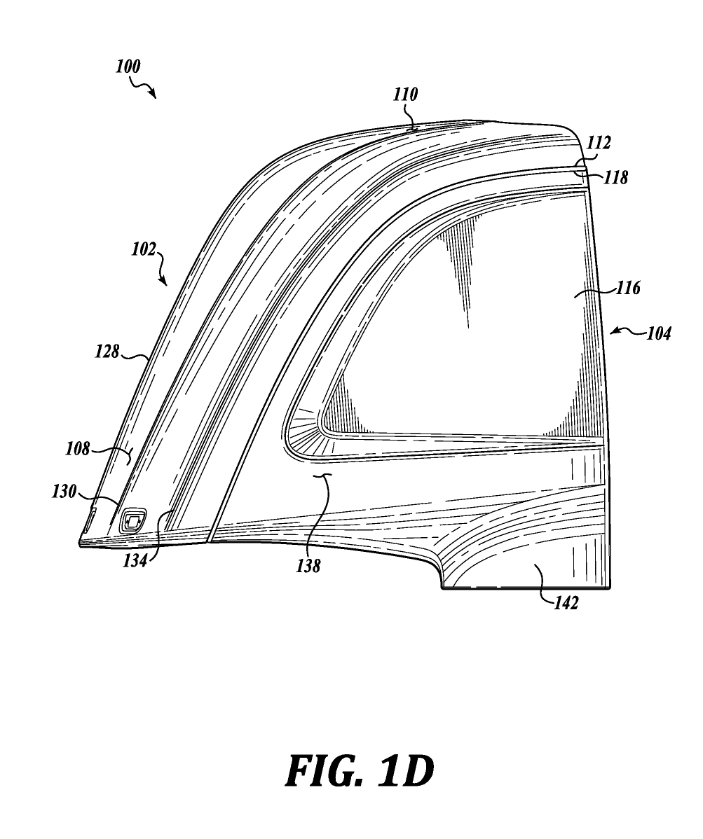

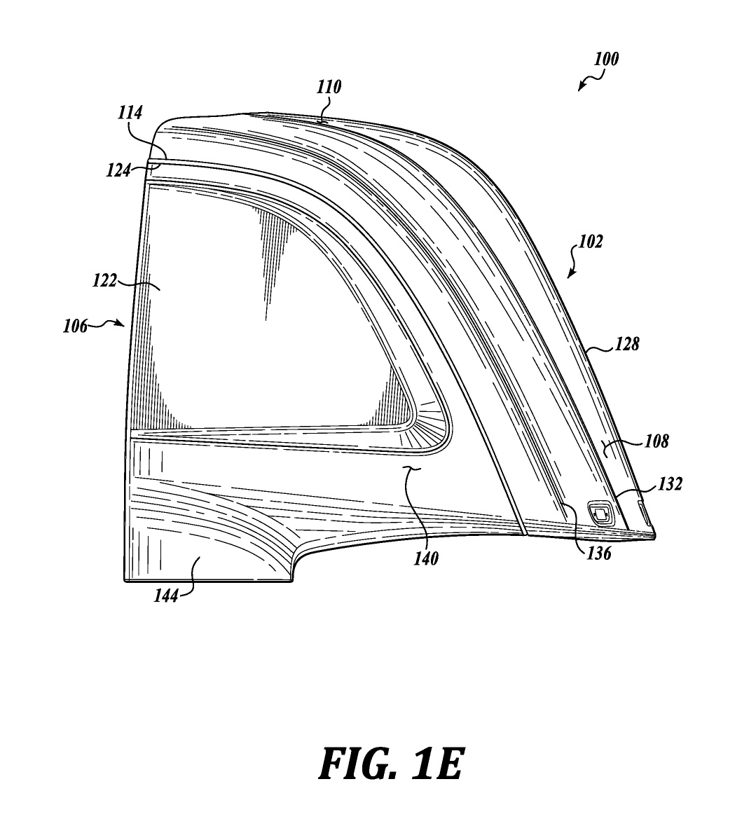

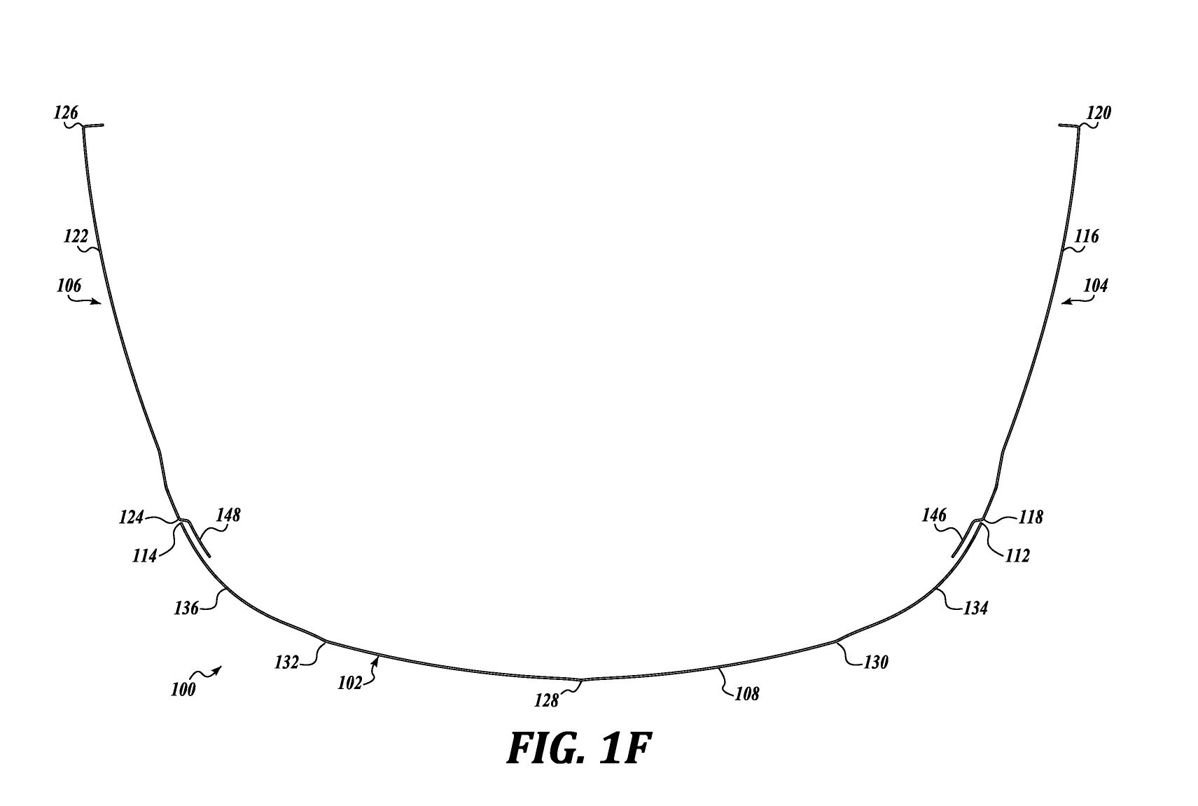

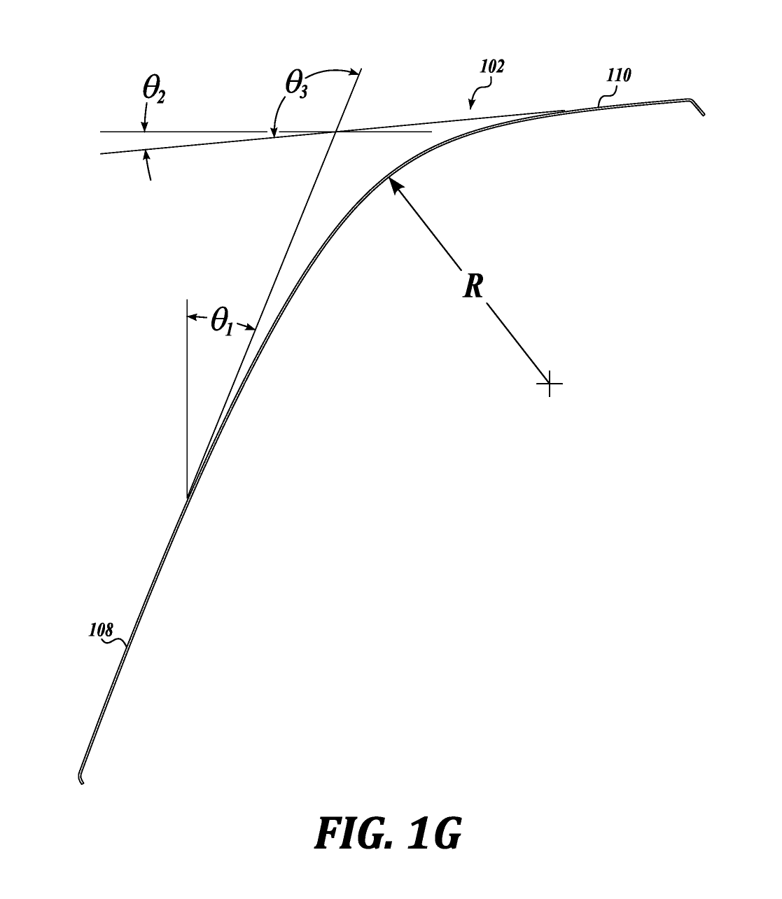

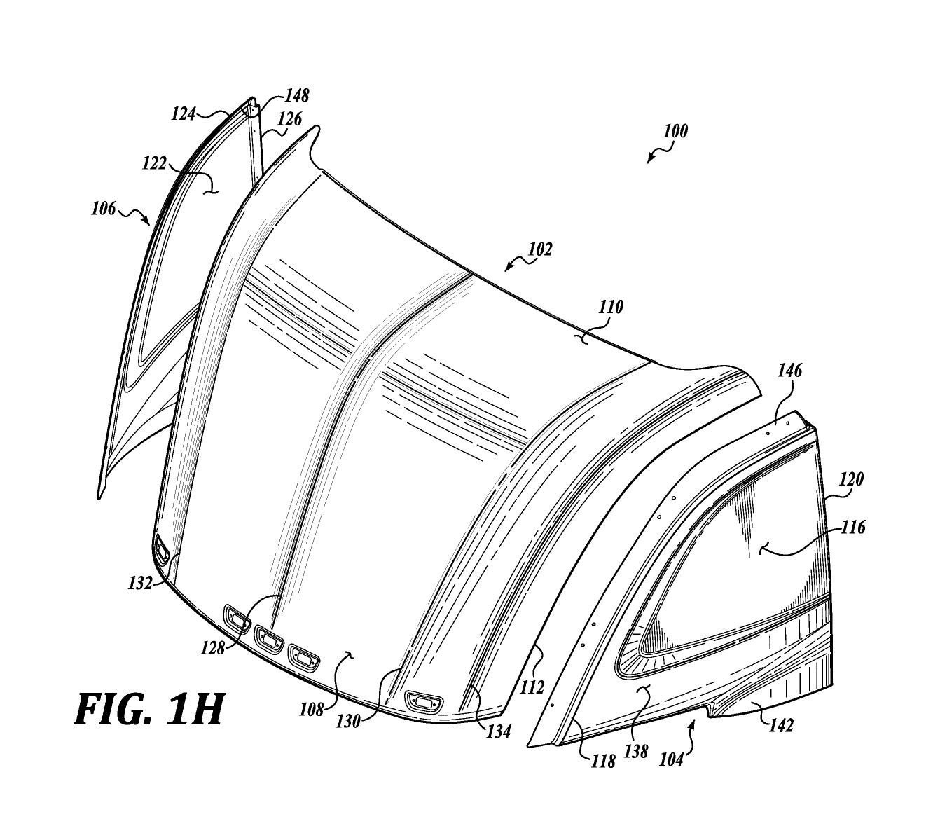

FIGS. 1A to 1H depict an embodiment of a three-piece cab roof fairing 100. More specifically, FIG. 1A depicts a perspective view of the roof fairing 100, FIG. 1B depicts another perspective view of the roof fairing 100, FIG. 1C depicts a front view of the roof fairing 100, FIG. 1D depicts a right side view of the roof fairing 100, FIG. 1E depicts a left side view of the roof fairing 100, FIG. 1F depicts a horizontal cross-sectional view of the roof fairing 100, FIG. 1G depicts a vertical cross-sectional view of the roof fairing 100, and FIG. 1H depicts an exploded view of the roof fairing 100.

The roof fairing 100 includes a central panel 102, a right side panel 104, and a left side panel 106. In one example, the central panel 102, the right side panel 104, and the left side panel 106 are made from a material that includes a metallic material (e.g., aluminum), a composite material (e.g., carbon fiber reinforced polymers), a plastic material (e.g., polyvinyl chloride), or any combination thereof. When assembled to form the roof fairing 100, the central panel 102, the right side panel 104, and the left side panel 106 are coupled together. In one example, the central panel 102, the right side panel 104, and the left side panel 106 are coupled by mechanical fasteners, such as bolts, rivets, and the like.

The central panel 102 is contoured to form a front portion 108 and a top portion 110. The central panel 102 includes a right side edge 112 and a left side edge 114. As shown in FIG. 1G, the front portion 108 forms an angle θ₁ with respect to vertical. In one embodiment, the angle θ₁ is the same as or based on an angle that the front of a cab (e.g., a windshield of the cab) forms with respect to vertical. The top portion 110 forms an angle θ₂ with respect to horizontal. The front portion 108 and the top portion 110 form an angle θ₃ with respect to each other. The corner between the front portion 108 and the top portion 110 is rounded and has a radius R. In one embodiment, the angle θ₁ is approximately 22.5°, such as in a range from about 20° to about 25°. In one embodiment, the angle θ₂ is approximately 5°, such as in a range from about 2.5° to about 7.5°. In one embodiment, the angle θ₃ is approximately 117.5°, such as in a range from about 115° to about 120°. In one embodiment, the radius R is approximately 17 inches, such as in a range from about 15 inches to about 19 inches.

In one embodiment, a characteristic of one or more of the front portion or the top portion is selected such that, when the roof fairing 100 is installed on a cab with a trailer, the roof fairing 100 produces a particular aerodynamic effect. In one example, the characteristic of one or more of the front portion or the top portion includes one or more of the angle θ₁, the angle θ₂, the angle θ₃, or the radius R. In one example, as discussed in greater detail below, one or more of the angle θ₁, the angle θ₂, the angle θ₃, or the radius R is selected such that air passing up from the cab is directed over a leading edge of the trailer.

The right side panel 104 includes a depressed portion 116, a side edge 118, and a back edge 120. When the right side panel 104 is coupled to the central panel 102, the right side edge 112 of the central panel 102 is aligned with the side edge 118 of the right side panel 104. The depressed portion 116 is configured such that air passing by the right side panel 104 toward the back edge 120 is directed away from the right side panel 104.

The left side panel 106 includes a depressed portion 122, a side edge 124, and a back edge 126. When the left side panel 106 is coupled to the central panel 102, the left side edge 114 of the central panel 102 is aligned with the side edge 124 of the left side panel 106. The depressed portion 122 is configured such that air passing by the left side panel 106 toward the back edge 126 is directed away from the left side panel 106.

In the particular embodiment shown in FIGS. 1A to 1H, the central panel 102 includes an inner ridge 128. The inner ridge 128 extends from the front portion 108 to the top portion 110 of the central panel 102. The central panel 102 also includes a right outer ridge 130 that extends from the front portion 108 to the top portion 110 of the central panel 102. The right outer ridge 130 is located between the inner ridge 128 and the right side edge 112. The central panel 102 also includes a left outer ridge 132 that extends from the front portion 108 to the top portion 110 of the central panel 102. The left outer ridge 132 is located between the inner ridge 128 and the left side edge 114. In one embodiment, the central panel 102 includes a right shoulder portion 134 that is located between the right outer ridge 130 and the right side edge 112 and the central panel 102 includes a left shoulder portion 136 that is located between the left outer ridge 132 and the left side edge 114.

In one embodiment, the depressed portion 116 of the right side panel 104 is located in a central portion 138 of the right side panel 104. In the particular embodiment shown in FIGS. 1A to 1H, the depressed portion 116 extends to and is flush with the back edge 120 of the right side panel 104. In another embodiment, the depressed portion 122 of the left side panel 106 is located in a central portion 140 of the left side panel 106. In the particular embodiment shown in FIGS. 1A to 1H, the depressed portion 122 extends to and is flush with the back edge 126 of the left side panel 106.

In one embodiment, the right side panel 104 includes an extended portion 142. The extended portion 142 extends further away from the top portion 110 of the central panel 102 than the front portion 108 extends away from the top portion 110. The extended portion 142 can be contoured in similar manner to one or more of a portion of the cab, a portion of the trailer, or another feature, such that aerodynamic drag is further reduced when the roof fairing 100 is installed on the cab with the trailer. In another embodiment, the left side panel 106 includes an extended portion 144. The extended portion 144 extends further away from the top portion 110 of the central panel 102 than the front portion 108 extends away from the top portion 110. The extended portion 144 can be contoured in similar manner to one or more of a portion of the cab, a portion of the trailer, or another feature, such that aerodynamic drag is further reduced when the roof fairing 100 is installed on the cab with the trailer.

In one embodiment, the right side panel 104 also includes an overlap portion 146 that extends from the side edge 118. When the right side panel 104 is coupled to the central panel 102, the overlap portion 146 overlaps the central panel 102 near the right side edge 112. In one example, one or both of the overlap portion 146 or the central panel 102 near the right side edge 112 includes one or more holes (e.g., circular holes, slots, etc.) that can be used to couple the right side panel 104 to the central panel 102. Mechanical fasteners can be placed through such holes to couple the right side panel 104 to the central panel 102. In another embodiment, the left side panel 106 also includes an overlap portion 148 that extends from the side edge 124. When the left side panel 106 is coupled to the central panel 102, the overlap portion 148 overlaps the central panel 102 near the left side edge 114. In one example, one or both of the overlap portion 148 or the central panel 102 near the left side edge 114 includes one or more holes (e.g., circular holes, slots, etc.) that can be used to couple the left side panel 106 to the central panel 102. Mechanical fasteners can be placed through such holes to couple the left side panel 106 to the central panel 102.

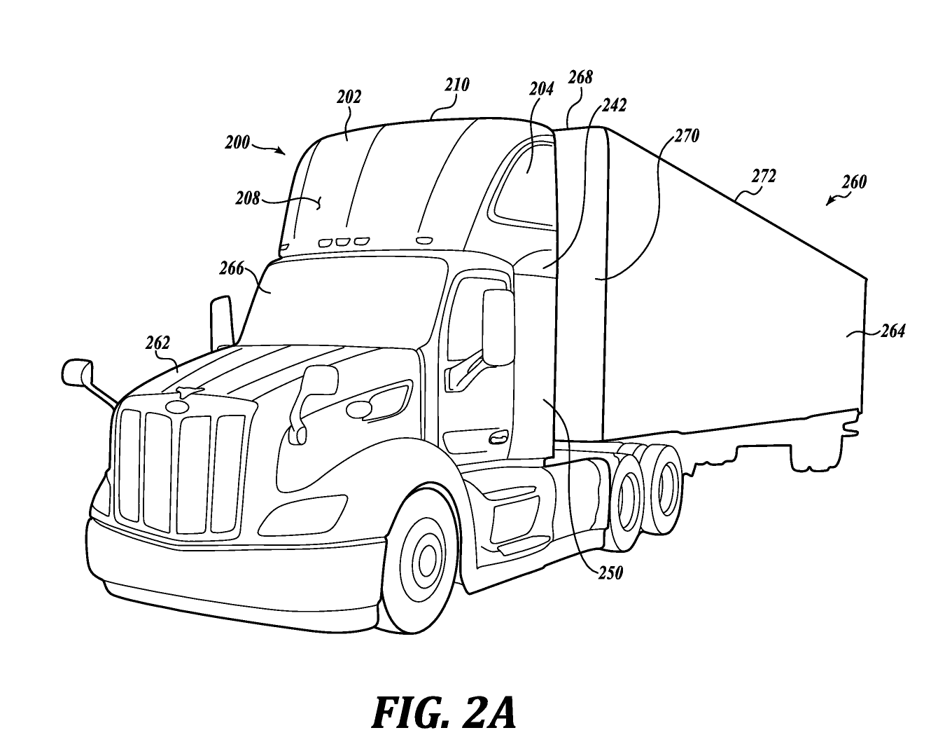

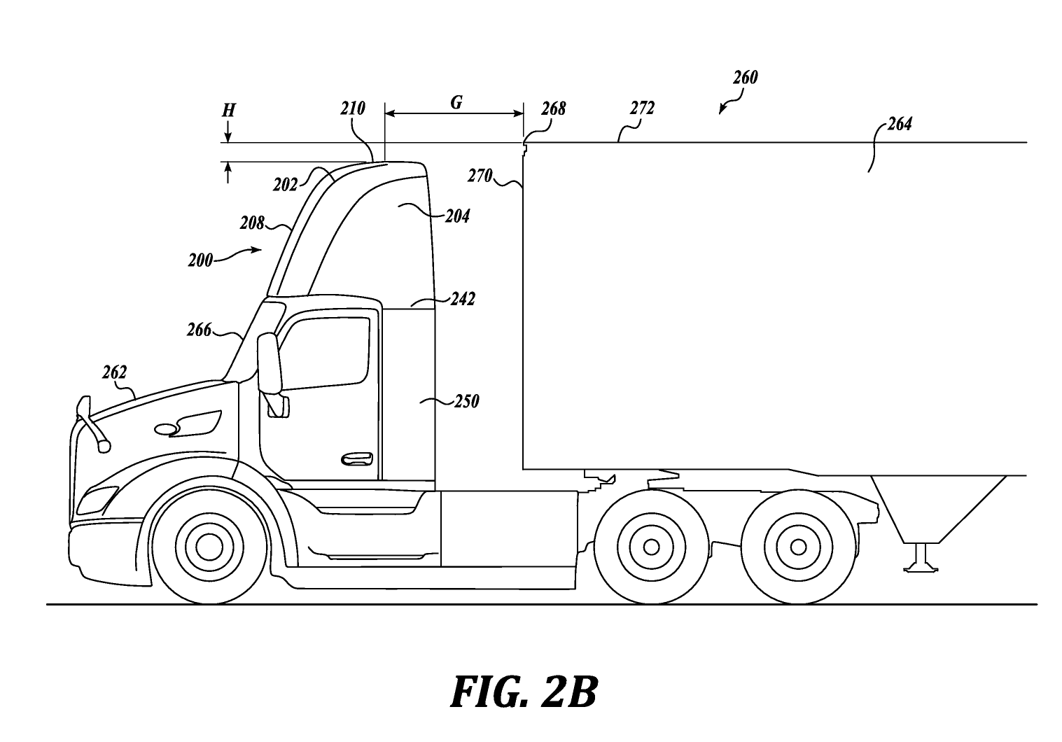

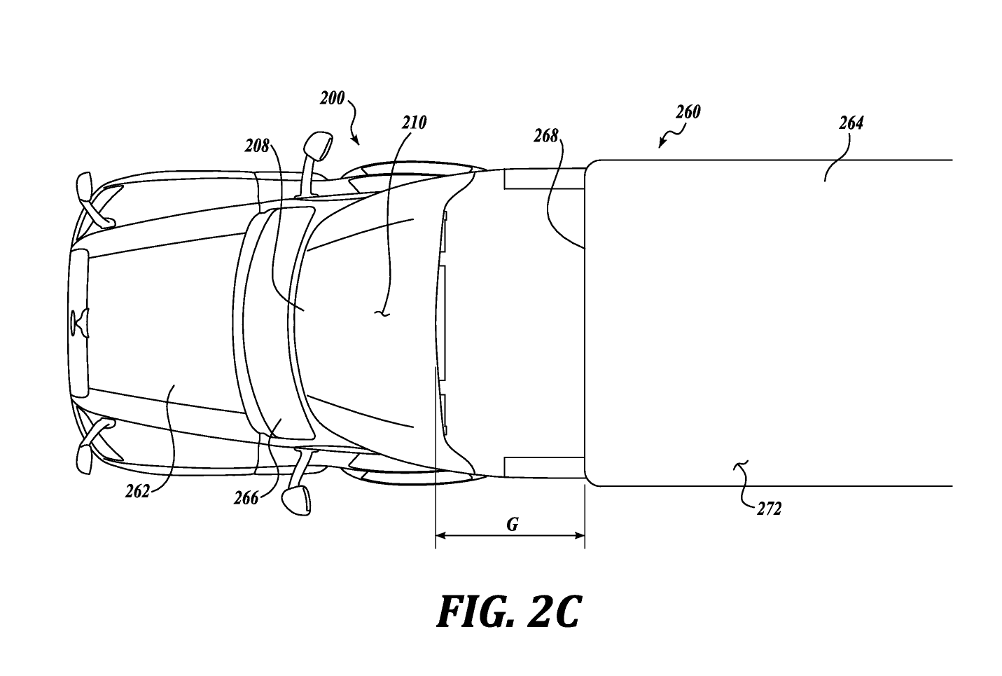

FIGS. 2A to 2C depict, respectively, perspective, side, and top views of an embodiment of a vehicle 260 with a roof fairing 200, in accordance with any of the roof fairings described herein. The vehicle 260 includes a cab 262 and a trailer 264. The roof fairing 200 is mounted on the cab 262 of the vehicle 260. The roof fairing 200 includes a central panel 202, a right side panel 204, and a left side panel (not shown). The central panel 202 includes a front portion 208 and a top portion 210. In one embodiment, the front portion 208 of the central panel 202 has an angle that is the same as or based on a front 266 (e.g., a windshield) of the cab 262. From the trailing edge of the top portion 210 to the leading top edge 268 of the trailer 264, a gap G and a height difference H exist.

As is visible in FIG. 2B, the height of the trailer 264 is greater than the height of the cab 262. Without the roof fairing 200 mounted on the cab 262, a portion of the front surface 270 of the trailer 264 below the leading top edge 268 would be exposed such that air would impinge directly on the front surface 270. Such a blunt surface is aerodynamically inefficient and can reduce the fuel efficiency of the vehicle 260.

The roof fairing 200 installed on the cab 262 increases the aerodynamic efficiency of the vehicle 200. As the vehicle 200 moves forward, air will pass up the front 266 of the cab 262 and the air will pass toward the roof fairing 200. The air passing up the front 266 of the cab 262 continues across the front portion 208 and the top portion 210 of the roof fairing 200. In one embodiment, one or more of an angle of the front portion 208, an angle of the top portion 210, an angle between the front portion 208 and the top portion 210, or a radius between the front portion 208 and the top portion 210 is selected such that the air flow passing across the front portion 208 and the top portion 210 is directed onto the top surface 272 of the trailer 264 and not toward the front surface 270. In one example, the one or more of the angle of the front portion 208, the angle of the top portion 210, the angle between the front portion 208 and the top portion 210, or the radius between the front portion 208 and the top portion 210 is selected based on one or more of the gap G and the height difference H. In some embodiments, such as in an embodiment of a sleeper cab with a sleeper compartment, the expected gap G can be in a range from about 42 inches to about 43 inches. In other embodiments, such as in an embodiment of a day cab without a sleeper compartment, the expected gap G can be in a range from about 48 inches to about 50 inches. In another embodiment, the point at which the trailer 264 is coupled to the cab 262 can vary such that the expended gap is in a range that is less than or equal to about 59 inches.

In the embodiment shown in FIGS. 2A to 2C, the right side panel 204 includes an extended portion 242 extends downward from the right side panel 204 toward a side fairing 250. The side fairing 250 has a profile similar to the extended portion 242. In one embodiment, the extended portion 242 and the side fairing 250 are configured to direct an airflow along a side of the cab 262 onto a side surface of the trailer 264 such that the airflow along the side of the cab 262 does not impinge on the front surface 270.

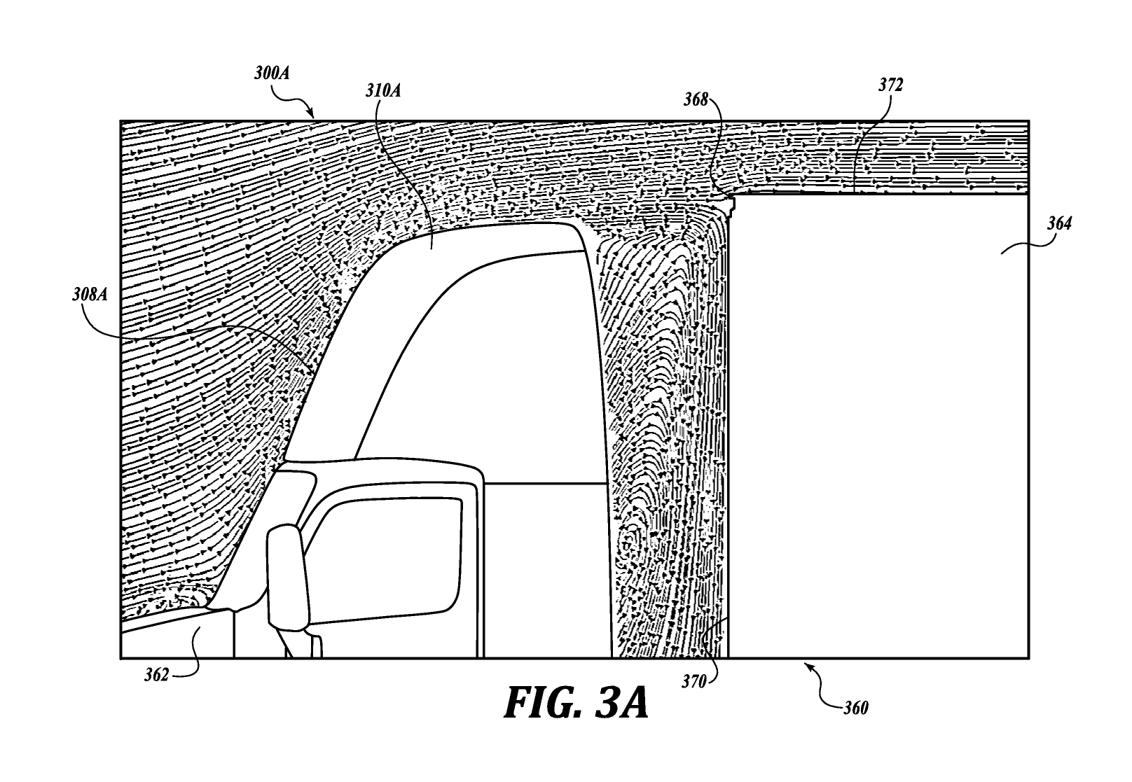

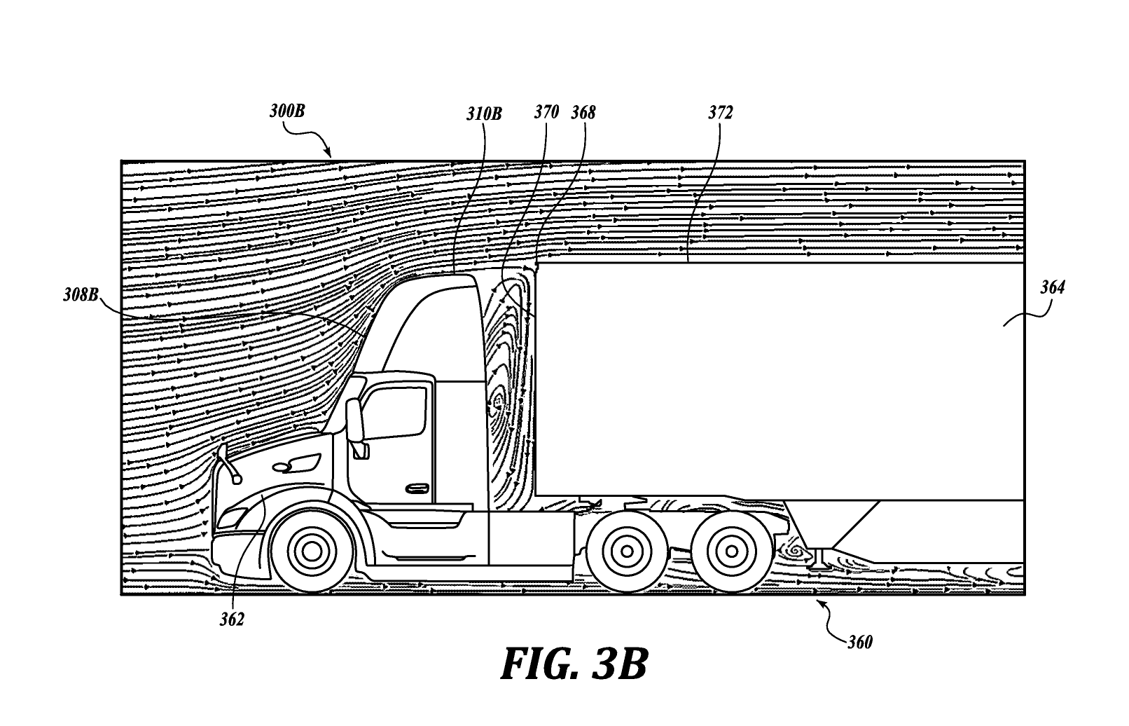

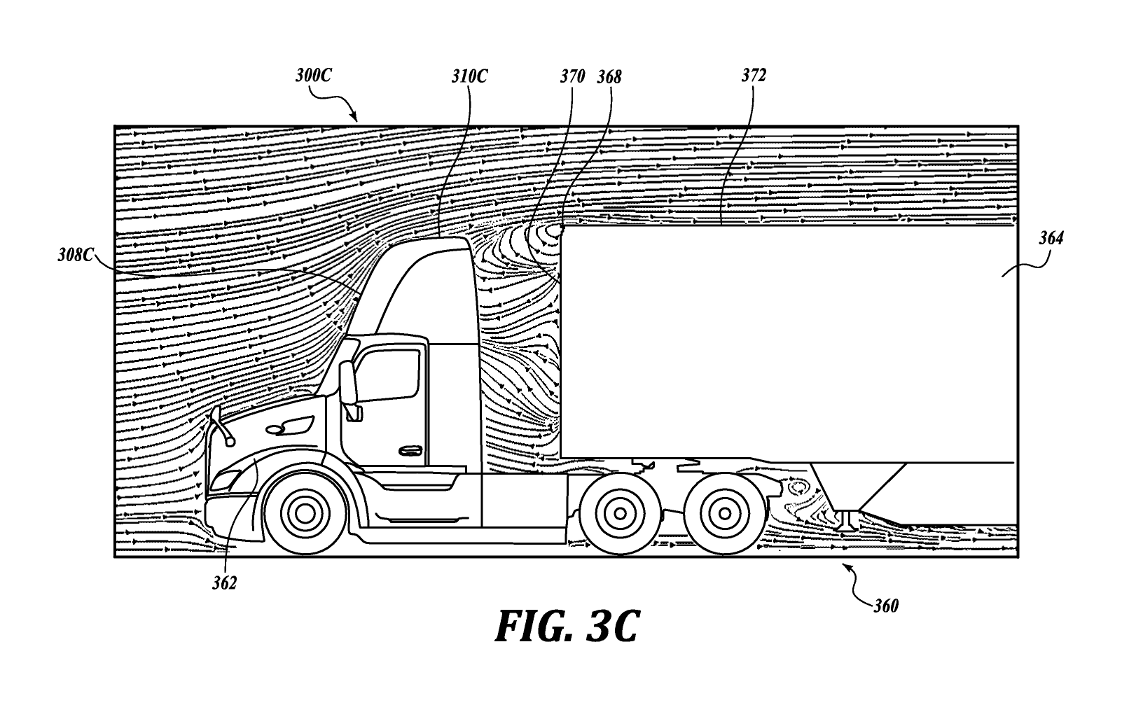

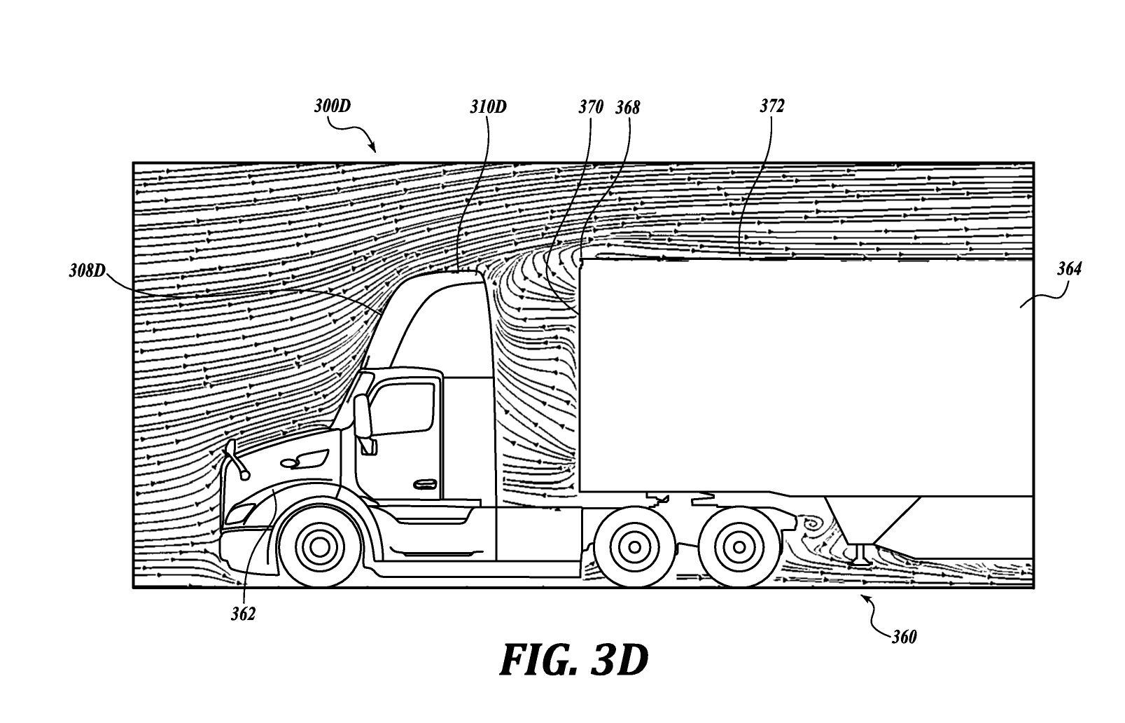

FIGS. 3A to 3D depict airflows over a vehicle 360 and embodiments of roof fairings 300A-300D, in accordance with any of the embodiments described herein. The vehicle 360 includes a cab 362 and a trailer 364. The trailer 364 has a top leading edge 368 with a front surface 370 below the top leading edge 368 and a top surface 372 behind the top leading edge 368. The roof fairings 300A-300D include front portions 308A-308D and top portions 310A-310D. The roof fairings 300A-300D direct air flows from the cab 362 across the front portions 308A-308D and the top portions 310A-310D toward the trailer 364. Each of FIGS. 3A to 3D depicts an embodiment of one of the roof fairings 300A-300D and the corresponding airflow over one of the front portions 308A-308D and one of the top portions 310A-310D toward the trailer 364.

In FIG. 3A, the airflow from the cab 362 passes over the front portion 308A and the top portion 310A toward the trailer 364. The front portion 308A and the top portion 310A are arranged such that the airflow passing over the front portion 308A and the top portion 310A is directed to the front surface 370. In FIG. 3B, the airflow from the cab 362 passes over the front portion 308B and the top portion 310B toward the trailer 364. The front portion 308B and the top portion 310B are arranged such that the airflow passing over the front portion 308B and the top portion 310B is directed to the top leading edge 368. In FIG. 3C, the airflow from the cab 362 passes over the front portion 308C and the top portion 310C toward the trailer 364. The front portion 308C and the top portion 310C are arranged such that the airflow passing over the front portion 308C and the top portion 310C is directed beyond the top leading edge 368 to the top surface 372. In FIG. 3D, the airflow from the cab 362 passes over the front portion 308D and the top portion 310D toward the trailer 364. The front portion 308D and the top portion 310D are arranged such that the airflow passing over the front portion 308D and the top portion 310D is directed even further beyond the top leading edge 368 to the top surface 372 than in FIG. 3C.

Airflow directed at the front surface 370 and/or the top leading edge 368 causes aerodynamic drag on the vehicle 360. Airflow directed at the top surface 372 of the trailer 364 results in some separation near the top leading edge 368, which results in aerodynamic drag on the vehicle 360. However, in general, the aerodynamic drag from airflow directed at the front surface 370 and/or the top leading edge 368 is worse than aerodynamic drag from airflow directed at the top surface 372 of the trailer 364. In some instances, the aerodynamic drag from airflow directed at the front surface 370 and/or the top leading edge 368 is ten times worse than the aerodynamic drag from airflow directed at the top surface 372 of the trailer 364. Thus, in some embodiments, a front portion and a top portion of a center panel are configured such that airflow over the front portion and the top portion is directed to the trailer beyond the top leading edge of the trailer.

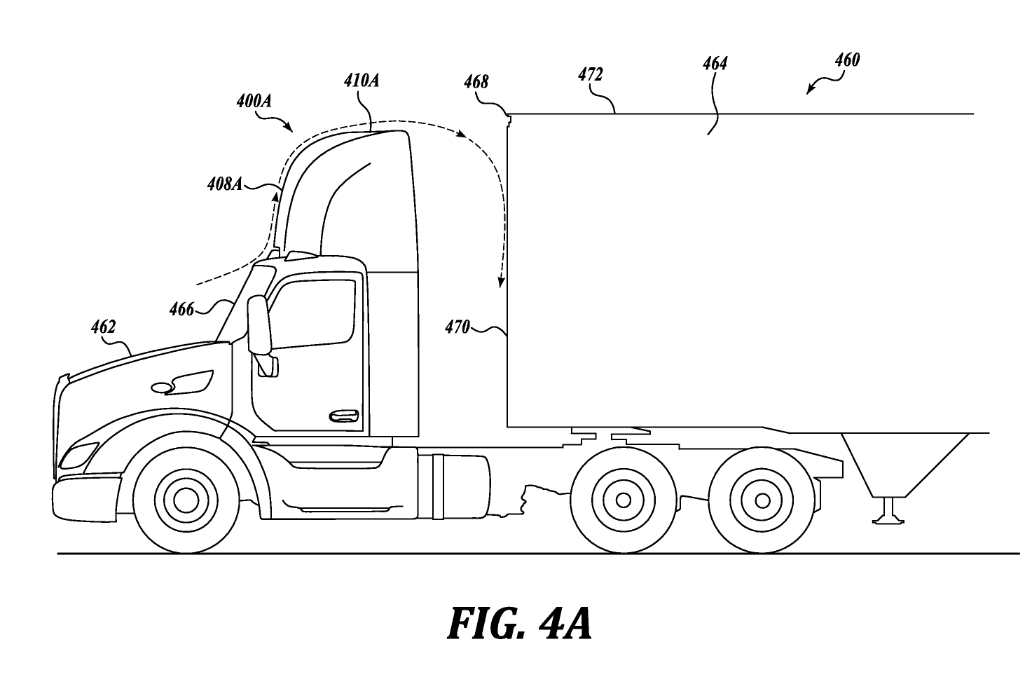

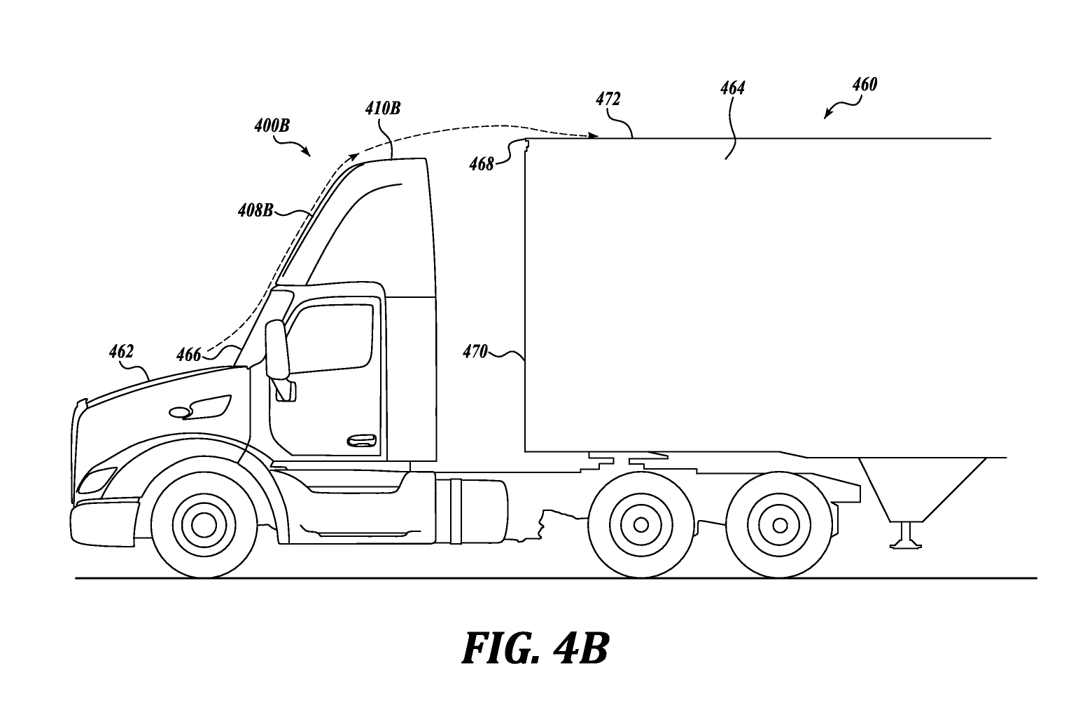

FIGS. 4A to 4B depict airflows over a vehicle 460 and embodiments of roof fairings 400A-400B, in accordance with any of the embodiments described herein. The vehicle 460 includes a cab 462 and a trailer 464. The cab has a front 466, such as a windshield. The trailer 464 has a top leading edge 468 with a front surface 470 below the top leading edge 468 and a top surface 472 behind the top leading edge 468. The roof fairings 400A-400B include front portions 408A-408B and top portions 410A-410B. The roof fairings 400A-400B direct air flows from the front 466 of the cab 462 across the front portions 408A-408B and the top portions 410A-410B toward the trailer 464. Each of FIGS. 4A and 4B depicts an embodiment of one of the roof fairings 400A-400B and the corresponding airflow over one of the front portions 408A-408B and one of the top portions 410A-410B toward the trailer 464.

In FIG. 4A, the roof fairing 400A has a front portion 408A that has a different contour than the front 466. In this particular arrangement of the front portion 408A and the top portion 410A, the airflow from the front 466 of the cab 462 passes across the front portion 408A and the top portion 410A and impinges on the top leading edge 468 and/or the front surface 470. In FIG. 4B, the roof fairing 400B has a front portion 408B that has a different contour than the front 466. In this particular arrangement of the front portion 408B and the top portion 410B, the airflow from the front 466 of the cab 462 passes across the front portion 408B and the top portion 410B and impinges on the top surface 472 of the trailer 464 beyond the top leading edge 468. The roof fairing 400A is less aerodynamically efficient than the roof fairing 400B because the roof fairing 400A is not arranged such that the airflow passing over the front portion 408A and the top portion 410A is directed beyond the top leading edge 468 to the top surface 472. Conversely, the roof fairing 400B is more aerodynamically efficient than the roof fairing 400A because the roof fairing 400B is arranged such that the airflow passing over the front portion 408B and the top portion 410B is directed beyond the top leading edge 468 to the top surface 472.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A vehicle, comprising:
a cab comprising a front, a first side, a second side, and a roof;
a trailer located behind the cab, the trailer comprising:
a top leading edge and a top surface adjoining the top leading edge, and extending rearwardly thereof, wherein the top surface is positioned higher than the roof;
a first side leading edge and a first side surface adjoining the first side leading edge, and extending rearwardly thereof; and
a second side leading edge and a second side surface adjoining the second side leading edge and extending rearwardly thereof; and
a roof fairing located on the roof of the cab, the roof fairing comprising:
a central panel having a front portion and a top portion;
a first side panel removably coupled to a first edge of the central panel, the first side panel having a first depressed portion inset from an outer surface in a central portion of the first side panel; and
a second side panel removably coupled to a second edge of the central panel, the second side panel having a second depressed portion inset from an outer surface in a central portion of the second side panel,
wherein a characteristic of one or more of the front portion or the top portion is selected such that the air flow passing across the front of the cab passes over the front portion and the top portion and is directed onto the top surface of the trailer rearwardly of the top leading edge, and wherein a characteristic of the first and second depressed portions is selected such that the air flow passing across the first and second sides of the cab passes over the first and second depressed portions and is directed onto the first and second side surfaces of the trailer rearwardly of the first and second side leading edges.

2. The vehicle of claim 1, wherein the characteristic of one or more of the front portion or the top portion includes one or more of an angle of the front portion, an angle of the top portion, an angle between the front portion and the top portion, or a radius between the front portion and the top portion.

3. The vehicle of claim 1, wherein the characteristic of one or more of the front portion or the top portion is further selected based on a height difference between a trailing edge of the top portion and the top leading edge.

4. The vehicle of claim 1, wherein the characteristic of one or more of the front portion or the top portion is selected based on a gap between a trailing edge of the top portion and the top leading edge.

5. The vehicle of claim 1, wherein the front portion has an angle that is based on the front of the cab.

6. The vehicle of claim 5, wherein the front of the cab includes a windshield.

7. (canceled)

8. The vehicle of claim 1, wherein the first side panel includes an extended portion extending down to overlap an area of the cab.

9. The vehicle of claim 8, further comprising a side fairing configured to interface the extended portion, wherein the side fairing has a profile similar to a profile of the extended portion.

10. The vehicle of claim 9, wherein the side fairing is configured to direct the air flow passing across the first and second sides of the cab onto the first and second side surfaces of the trailer rearwardly of the first and second side leading edges.

11. A cab roof fairing assembly mountable to a cab of a vehicle having a gap between the cab and a trailer, the trailer having a top surface leading edge positioned higher than the cab and side surface leading edges positioned wider than the cab, the cab roof fairing assembly comprising:
a central panel contoured to form a front portion and a top portion, wherein the central panel comprises a first side edge and a second side edge;
a first side panel comprising a third side edge and a first depressed portion, wherein the first side panel is removably couplable to the central panel such that the first side edge of the central panel is aligned with the third side edge of the first side panel when coupled, and wherein the first depressed portion is inset from an outer surface in a central portion of the first side panel; and
a second side panel comprising a fourth side edge and a second depressed portion, wherein the second side panel is removably couplable to the central panel such that the second side edge of the central panel is aligned with the fourth side edge of the second side panel when coupled, and wherein the second depressed portion is inset from an outer surface in a central portion of the second side panel,
wherein, when the cab roof fairing assembly is mounted to the cab of the vehicle, the front portion and the top portion form an angle in a range from about 115° to about 120° configured to direct air passing up from the cab over the gap to an area of the trailer rearwardly of the top surface leading edge, and wherein the first and second depressed portions are configured to direct air passing over the first and second side panels around the gap to an area on the trailer rearwardly of the side surface leading edges.

12. The cab roof fairing assembly of claim 11, further comprising:
an inner ridge extending from the front portion to the top portion of the central panel.

13. The cab roof fairing assembly of claim 12, further comprising:
a first outer ridge extending from the front portion to the top portion of the central panel, wherein the first outer ridge is located between the inner ridge and the first side edge; and
a second outer ridge extending from the front portion to the top portion of the central panel, wherein the second outer ridge is located between the inner ridge and the second side edge.

14. The cab roof fairing assembly of claim 13, wherein the central panel comprises a first shoulder portion located between the first outer ridge and the first side edge, and wherein the central panel comprises a second shoulder portion located between the second outer ridge and the second side edge.

15. (canceled)

16. The cab roof fairing assembly of claim 11, wherein the first depressed portion extends to and is flush with a back edge of the first side panel.

17. (canceled)

18. The cab roof fairing assembly of claim 1, wherein a radius between the front portion of the central panel and the top portion of the central panel is in a range from about 15 inches to about 19 inches.

19. The cab roof fairing assembly of claim 1, wherein the first side panel comprises an extended portion, and wherein the extended portion extends further away from the top portion of the central panel than the front portion extends away from the top portion.
